(19) United States
(12) Patent Application Publication
(10) Pub. No.: US 2015/0246756 A1
(43) Pub. Date: Sep. 3, 2015

(54) CAP FOR A CONTAINER

(71) Applicant: Megan Wampler, Kansas City, MO (US)

(72) Inventor: Megan Wampler, Kansas City, MO (US)

(21) Appl. No.: 14/632,357

(22) Filed: Feb. 26, 2015

Related U.S. Application Data
(60) Provisional application No. 61/945,937, filed on Feb. 28, 2014.

(51) Int. Cl. B65D 41/16; B67B 7/00

(52) U.S. Cl. CPC B65D 41/16; B67B 7/00

(57) ABSTRACT

An improved cap for a container broadly includes an end cap, a sidewall, and a radially-extending tab. The cap is removed by grasping and lifting the tab, deforming the end cap and sidewall, and removing the cap from the container, or by applying circumferential force to the tab and unscrewing the cap.

### RELATED APPLICATIONS

This application claims the benefit of U.S. Provisional Patent Application No. 61/945,937, filed Feb. 28, 2014 that is incorporated by specific reference in its entirety herein.

### FIELD OF THE INVENTION

The present invention relates to containers. More particularly, the invention relates to easily removable caps for containers.

### BACKGROUND

Caps have long been used on bottles to seal the contents therein. Various types of bottles use a myriad of different cap types with two common types being a screw cap and a crown cork cap. The screw cap can be removed by hand. The crown cork, traditionally, is removed by using a bottle opener. The “twist off” crown cap is an additional variant of the crown cap that allows for opening by hand in addition to opening by using a bottle opener.

Regardless of variety of bottle cap, each cap has its disadvantages. First, all caps can be applied too tightly and can be difficult to remove. Second, at times, bottle caps can have sharp points or rough sides and can cause pain while opening. Additionally, crown caps still have the disadvantage that they need a separate opener to remove the cap from the bottle.

### SUMMARY

The present invention solves the above-described problems and provides a distinct advance in the field of easily removable caps for containers. The problem of removing a cap from a bottle is solved by including a tab on the cap of the container. More particularly, the present invention provides a radially-extending tab that extends from a sidewall of the cap. Additionally, embodiments of the present invention make removing tightly fitted caps easier to remove and reduce the causes for pain when removing caps.

One embodiment of an improved cap for a container includes an end cap, a sidewall, and a tab.

The endcap seals against an edge of a container to sealing the contents of the container therein. The sidewall extends from a peripheral edge of the endcap for matingly receiving a portion of the container therewithin. The cap and the sidewall, collectively, form a conventional cap for a resealable container, such as would be found on various types of conventional bottles.

The tab extends radially from the sidewall for enabling easier removal of the cap from the container. In the first embodiment, the endcap, sidewall, and tab are formed from polypropylene, but in other embodiments they may be formed from various plastics, nylons, metals, elastomeric materials, or the like.

A second embodiment of an improved cap for a container comprises an end cap, a sidewall, and a tab.

The endcap is circular and smoothly lofts into the sidewall. The sidewall extends at a generally perpendicular direction from endcap. The sidewall includes a plurality of depressions extending from a second end of the sidewall. The sidewall and endcap collectively form a generally conventional 21-tooth crown cork bottle cap.

The tab extends from the outer side of the sidewall for easily removing the cap and further comprises a grip. In this embodiment, the tab extends from only a portion of the outer side of the sidewall and, thus, a conventional bottle opener may be used to remove the cap, if desired. In this embodiment, the endcap, sidewall, and tab are formed from a single piece of stamped aluminum.

In use, embodiments of an improved cap for a container replaces a conventional removable cap and would generally be supplied to a user installed on a neck of a container. The user may then remove the cap in two distinctly different ways.

In a first method for removing and replacing the cap, the user grasps the tab. The user then lifts the tab away from a body of the container causing deformation in the cap and allowing the cap to be removed from the neck of the container.

In a second method for removing and replacing the cap, particularly for containers using helical grooves, the user applies a circumferential force to the tab to rotate and loosen the cap. By nature of the increased radius provided by the tab, more torque may be applied by the user to the cap without requiring additional force as compared to conventional caps.

### BRIEF DESCRIPTION OF THE DRAWING FIGURES

Embodiments of the present technology are described in detail below with reference to the attached drawing figures, wherein:

FIG. 1 is a front perspective view of a cap constructed in accordance with a first embodiment of the invention;

FIG. 2 is a right perspective view of the cap of FIG. 1;

FIG. 3 is a back perspective view of the cap of FIG. 1;

FIG. 4 is a left perspective view of the cap of FIG. 1;

FIG. 5 is a perspective view of the cap of FIG. 1, particularly illustrating the cap from above;

FIG. 6 is a perspective view of the cap of FIG. 1, particularly illustrating the cap from below;

FIG. 7 is a front perspective view of a cap constructed in accordance with a second embodiment of the invention;

FIG. 8 is a right perspective view of the cap of FIG. 7;

FIG. 9 is a back perspective view of the cap of FIG. 7;

FIG. 10 is a left perspective view of the cap of FIG. 7;

FIG. 11 is a perspective view of the cap of FIG. 7, particularly illustrating the cap from below;

FIG. 12 is a perspective view of the cap of FIG. 7, particularly illustrating the cap from above;

FIG. 13 is a perspective view of a cap, particularly illustrating a first embodiment of a method for using an embodiment of a cap;

FIG. 14 is a perspective time series of a cap, particularly illustrating a second embodiment of a method for using an embodiment of a cap at a first time;

FIG. 15 is a perspective time series of the cap of FIG. 14 at a second time; and

FIG. 16 is a perspective time series of the cap of FIG. 14 at a third time.

The drawing figures do not limit the present invention to the specific embodiments disclosed and described herein. The drawings are not necessarily to scale, emphasis instead being placed upon clearly illustrating the principles of the technology.

### DETAILED DESCRIPTION

The following detailed description of various embodiments of the present technology references the accompanying drawings that illustrate specific embodiments in which the technology can be practiced. The embodiments are intended to describe aspects of the technology in sufficient detail to enable those skilled in the art to practice them. Other embodiments can be utilized and changes can be made without departing from the scope of the technology. The following detailed description is, therefore, not to be taken in a limiting sense. The scope of the present technology is defined only by the appended claims, along with the full scope of equivalents to which such claims are entitled.

Note that in this description, references to “one embodiment” or “an embodiment” mean that the feature being referred to is included in at least one embodiment of the present invention. Further, separate references to “one embodiment” or “an embodiment” in this description do not necessarily refer to the same embodiment; however, such embodiments are also not mutually exclusive unless so stated, and except as will be readily apparent to those skilled in the art from the description. For example, a feature, structure, act, etc. described in one embodiment may also be included in other embodiments. Thus, the present invention can include a variety of combinations and/or integrations of the embodiments described herein.

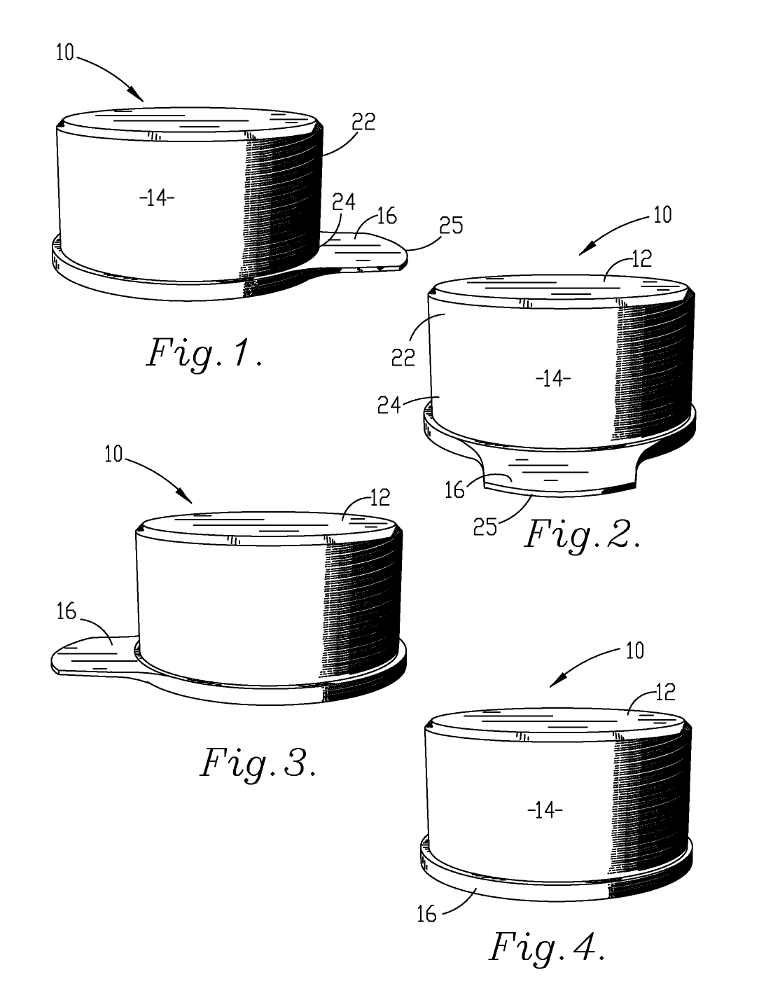

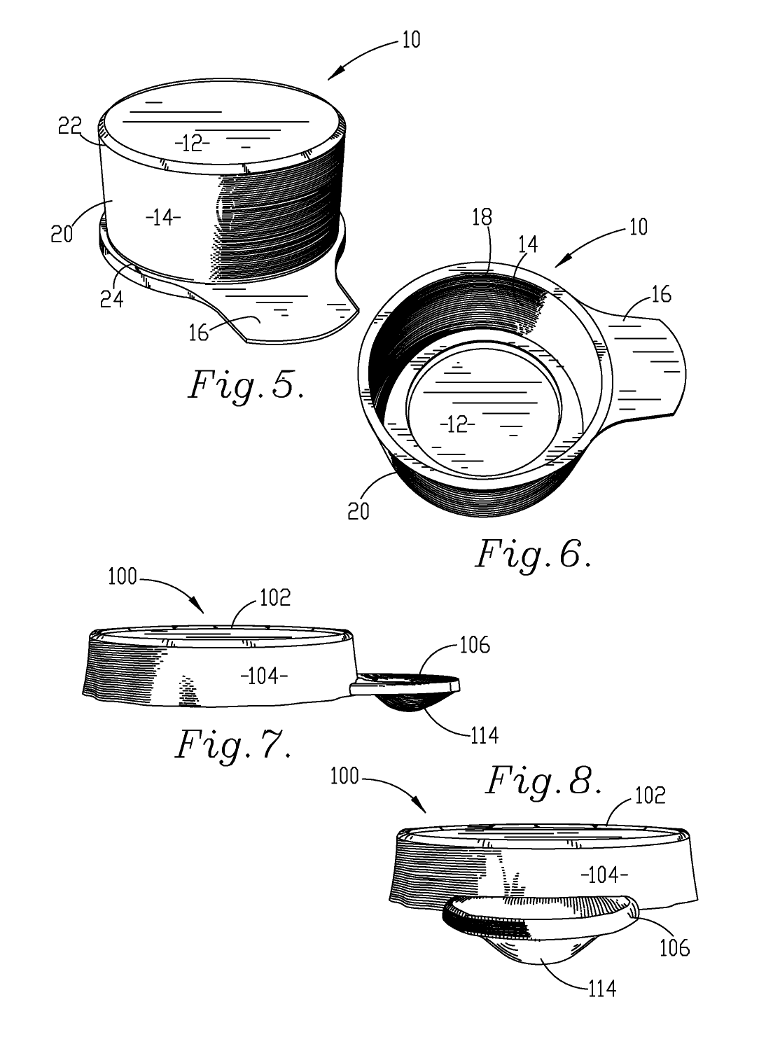

Turning now to the drawing figures and, in particular FIGS. 1-6, a cap 10 for a container comprises an end cap 12, a sidewall 14, and a tab 16.

The endcap 12 is circular and seals against an edge of a container to sealing the contents of the container therein. The cap 12 may include a variety of seals or other structures to more completely seal the opening of the container, as is generally known in the art.

The sidewall 14 extends from a peripheral edge of the endcap 12 at a generally perpendicular orientation for matingly receiving a portion of the container therewithin. The sidewall 14 includes an inner side 18 and an outer side 20 as well as a first end 22 and second end 24. The sidewall 14 may contain ridges, flanges, helical grooves or the like to enable the sidewall 14 to be removably retained on the container, as is known in the art. The sidewall 14 may also include various ridges and grooves on the outer side 20. The cap 12 and the sidewall 14, collectively, form a conventional cap for a resealable container, such as would be found on various types of conventional bottles. In this embodiment the sidewall is connected to the endcap 12 at or near its first end 22.

The tab 16 extends radially from the outer side 20 of the sidewall 14 for enabling easier removal of the cap 10 from the container. In this embodiment, the tab 16 extends radially from or near the second end 24 of the sidewall 14 and continues circumferentially around the second end 24 of the sidewall 14, but various locations are possible including near the first end 22 or at various points between the first end 22 and second end 24. In this embodiment, the tab 16 is integrally formed with the sidewall 14 and the endcap 12, but in other embodiments, the tab 16 may be separately formed and and attached with various conventional methods. In this embodiment, the endcap 12, sidewall 14, and tab 16 are formed from polypropylene, but in other embodiments, the endcap 12, sidewall 14, and tab 16 may be formed from various plastics, nylons, metals, elastomeric materials, or the like. In some embodiments, the tab 16 may include a rounded distal edge 25 to allow greater comfort when removing the cap 10. In this embodiment the length of the tab 16, measured from the sidewall 14 to the distal edge 25 is 3 cm, but in other embodiments the tab 16 may be between 1 cm and 4 cm. Additionally, in this embodiment, the tab 16 measures 2 cm wide, as measured perpendicular to a radius centered on the endcap 12, but in various embodiments the tab 16 may be between 0.5 cm and 4 cm. Some embodiments may also taper or change the shape of the tab 16 so that the width measured near the sidewall 14 is narrower or wider than the width of the tab measured near to the distal edge 25. In other embodiments, the tab 16 may also be formed so as to resemble various shapes, such as letters, numbers, logos, words, or the like. Thus, it is contemplated that the tab 16 may also contain voids or windows, depressions, relief, bumps, protuberances, or the like, to enhance the appearance of such shapes, to save on material costs, or for purely aesthetic reasons.

In use, the cap 10 replaces a conventional removable cap and would generally be supplied to a user installed on a neck of a container 26. The user may then remove the cap 10 in two distinctly different ways.

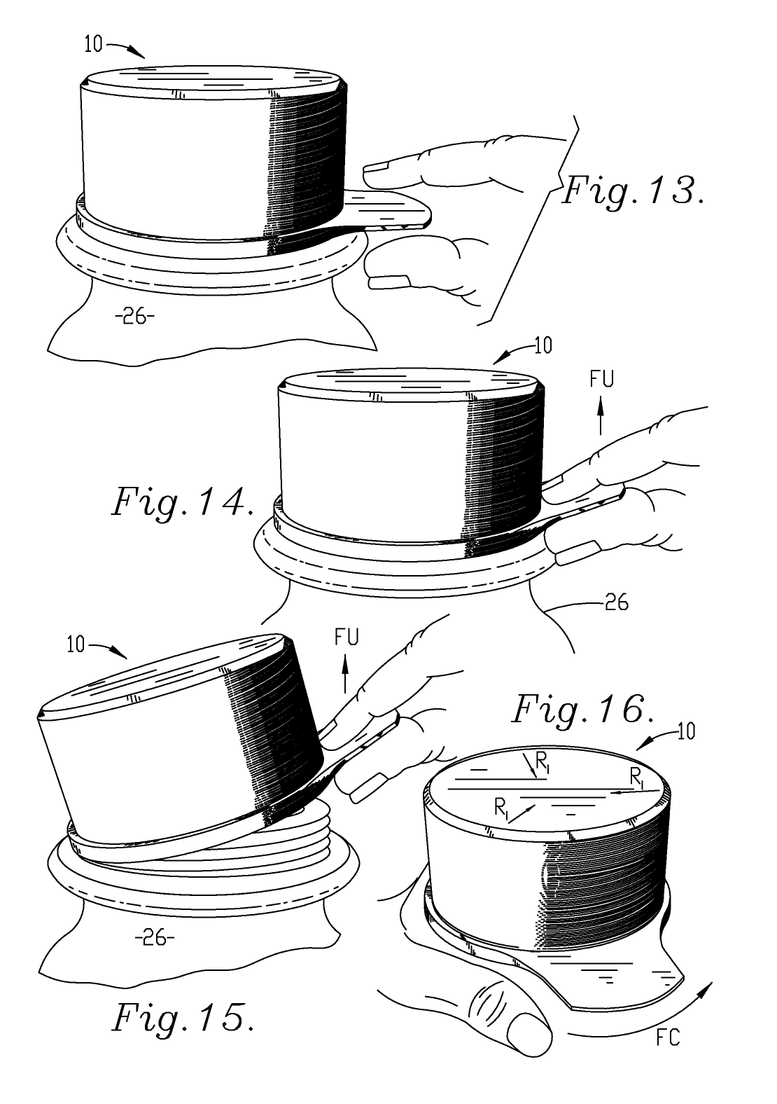

Turning to FIGS. 13-15, in a first method for removing and replacing the cap 10, the user places the tab 16 between a thumb and forefinger and grips the tab 16 therebetween. The user then lifts the tab 16 in an upward direction FU away from a body of the container causing deformation in the cap 10 and allowing the cap 10 to be removed from the neck of the container 26.

Turning now to FIG. 16, in a second method for removing and replacing the cap 10, particularly for containers using helical grooves, the user applies a force to the tab 16 in a circumferential direction Fc to rotate and loosen the cap 10. By nature of the increased radius provided by the tab 16, more torque may be applied by the user to the cap 10 without requiring additional force as compared to conventional caps. Additionally, the tab 16 allows the user to apply force directly in the circumferential direction Fc through the tab 16, rather than applying inward radial pressure Ri on the sidewall 14 and then applying a circumferential twisting force thereto. Because the force may be applied directly to the tab 16, rather than the sidewall 14 as in a conventional removable cap, the force required is less than in conventional removable caps and thus is easier for those with less hand-strength, such as the elderly and children. The cap 10 may be replaced and tightened by substantially reversing the steps of this method.

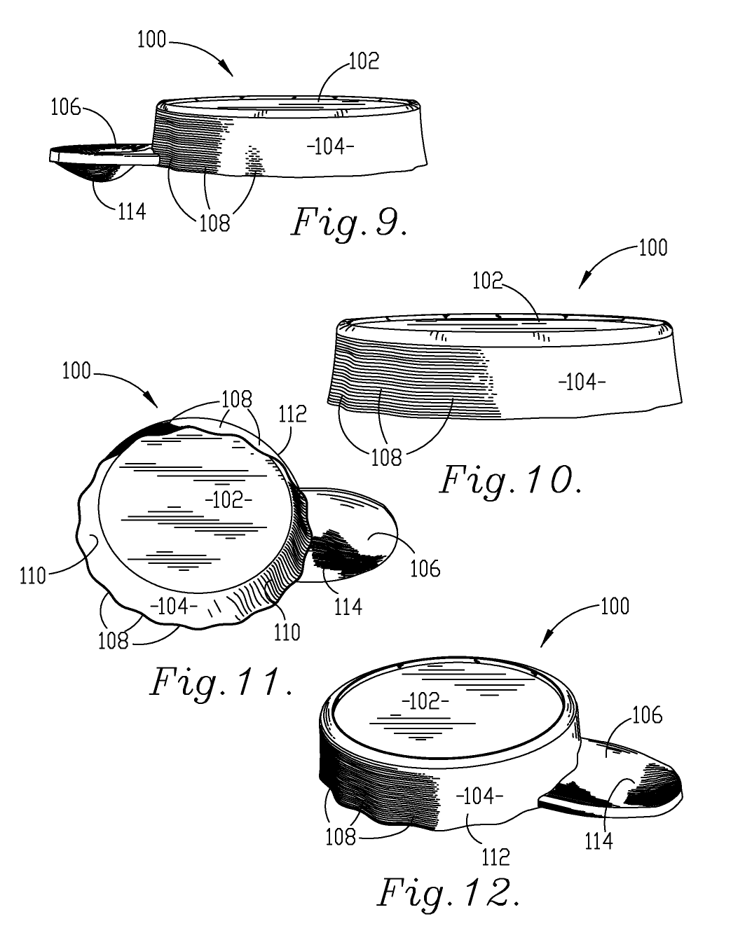

Turning now to FIGS. 7-12, another embodiment of a cap 100 is illustrated. In this embodiment, the cap 100 comprises an end cap 102, a sidewall 104, and a tab 106.

The endcap 102 is circular and smoothly lofts into the sidewall 104. The sidewall 104 extends at a generally perpendicular direction from endcap 102. The sidewall 104 includes a plurality of depressions 108 extending from a second end of the sidewall 104. The sidewall 104 includes an innner side 110 and an outer side 112. The sidewall 104 and endcap 102 collectively form a generally conventional 21-tooth crown cork bottle cap.

The tab 106 extends from the outer side 112 of the sidewall 104 for easily removing the cap 100 and further comprises a grip 114 for more easily handling the tab 106 and to avoid discomfort to a user while manipulating the tab 106. In this embodiment, the tab 106 extends from only a portion of the outer side 112 of the sidewall 104 and, thus, a conventional bottle opener may be used to remove the cap 100, if desired. In other embodiments, the grip 106 may include alternate configurations of raised portions, surface patterns, scoring, or the like, or combinations thereof. In this embodiment, the tab 106 is integrally formed with the sidewall 104 and the endcap 102, but in other embodiments, the tab 106 may be separately formed and attached with various conventional methods, such as weld beads, adhesives, or the like. In this embodiment, the endcap 102, sidewall 104, and tab 106 are formed from a single piece of stamped aluminum, but in other embodiments, the endcap 102, sidewall 104, and tab 106 may be formed from various plastics, nylons, metals, elastomeric materials, or the like.

The methods of using cap 10, described above in relation to the first embodiment of a cap 10, are also applicable to the second embodiment of the cap 100, as well as other various embodiments.

Although the invention has been described with reference to the preferred embodiment illustrated in the attached drawing figures, it is noted that equivalents may be employed and substitutions made herein without departing from the scope of the invention as recited in the claims.

What is claimed is:

1. An improved cap for a container comprising:
a circular end cap;
a sidewall disposed along a peripheral edge of the circular end cap and extending from the peripheral edge of the end cap in a generally perpendicular orientation from the first end of the sidewall, and
a tab extending from the sidewall.

2. The improved cap for a container of claim 1, wherein the tab extends radially from the sidewall.

3. The improved cap for a container of claim 1, wherein the tab extends circumferentially along the second end of the sidewall.

4. The improved cap for a container of claim 1, the tab further comprising a grip on a side of the tab.

5. The improved cap for a container of claim 4, the grip comprising a depression in the tab.

6. The improved cap for a container of claim 4, the grip comprising a knurled pattern on the tab.

7. The improved cap for a container of claim 1, wherein the circular end cap and the sidewall comprise a 21-tooth crown cork cap.

8. The improved cap for a container of claim 1, wherein the circular end cap, the sidewall, and the tab is fabricated from aluminum, steel, nickel, polypropylene, nylon, other metals, other plastics, or elastomeric materials.

9. The improved cap for a container of claim 1, wherein a length of the tab is between 1 cm and 4 cm.

10. The improved cap for a container of claim 1, wherein a width of the tab is between 0.5 cm and 4 cm.

11. The improved cap for a container of claim 1, the tab further comprising a rounded distal edge.

12. The improved cap for a container of claim 1, wherein a width of the tab is wider near the sidewall and smoothly tapers to a more narrow width near the distal tip.

13. A method of removing an improved cap from a container having an open end and a body where the removing does not damage the cap, the method comprising:
a) placing opposable fingers on opposing sides of a radially extending tab;
b) applying pressure on the tab in a direction away from the body of the container; and
c) lifting the cap from the open end of the container.

14. The method of removing an improved cap from a container of claim 13, further comprising:
d) causing the cap to deform.

15. A method of removing a cap from a container having an open end and a body where the removing does not damage the cap, the method comprising:
a) placing an appendage on a side of a radially extending tab;
b) applying pressure with the appendage in a circumferential direction.

16. The method of removing a cap from a container of claim 15, further comprising:
c) rotating the cap until the cap releases from the container; and
d) removing the cap from the container.
